(19) United States
(12) Patent Application Publication
(10) Pub. No.: US 2015/0158729 A1
(43) Pub. Date: Jun. 11, 2015

(54) Method for Manufacturing Nano-Graphene Sheets

(71) Applicant: Enerage Inc., Yilan County (TW)

(72) Inventors: Mark Y WU, Yilan County (TW); Cheng-Yu HSIEH, Yilan County (TW); Geng-Wei LIN, Yilan County (TW); Ping-Yun YEH, Yilan County (TW); Tsung-Han CHEN, Yilan County (TW)

(21) Appl. No.: 14/303,409

(22) Filed: Jun. 12, 2014

(30) Foreign Application Priority Data
Dec. 11, 2013 (TW) 102145702

(51) Int. Cl. C01B 31/04

(52) U.S. Cl. CPC C01B 31/0469; C01B 2204/32

(57) ABSTRACT

A method for manufacturing nano-graphene sheets, includes: intercalating and oxidizing a graphite material to form a graphite oxide by mixing the graphite material with an intercalation agent and oxidant; contacting the graphite oxide with a heat source to thermally flake the graphite oxide to nano-graphite sheets; suspending the nano-graphite sheets in a liquid medium and applying a mechanical shear force larger than 5,000 psi to mechanically flake the nano-graphite sheets for reducing the lateral size and thickness to form a nano-graphene suspension solution; separating the nano-graphene sheets from the nano-graphene suspension solution and drying the nano-graphene sheets; and finally reducing and heat treating the nano-graphene sheets to lower the oxygen content to less than 3 wt % and decrease the crystal defects.

### CROSS-REFERENCE TO RELATED APPLICATION

This application claims the priority of Taiwanese patent application No. 102145702, filed on Dec. 11, 2013, which is incorporated herewith by reference.

### BACKGROUND OF THE INVENTION

1. Field of the Invention

The present invention generally relates to a method for manufacturing nano-graphene sheets, and more specifically to a method for manufacturing nano-graphene sheets by a mechanical flaking process with high shear force to flake or smash the nano-graphite sheets so as to improve the nano-graphene sheets having more uniform particle size and specific surface area.

2. The Prior Arts

With a thickness of only one carbon atom, monolayer graphite also called graphene is generally a thin film formed of a monolayer of carbon atoms which are tightly packed in a two-dimensional honeycomb crystal lattice by the hybrid chemical bond (sp2). Andre Geim and Konstantin Novoselov, who successfully obtained graphene from a piece of graphite by using adhesive tape at the University of Manchester in the UK in 2004, were awarded the Nobel Prize in Physics for 2010.

Graphene is the thinnest and hardest material in the world for now, and additionally has thermal conductivity greater than that of carbon nano-tube and diamond. Especially, its electron mobility at room temperature is higher than the carbon nano-tube and silicon crystal. Graphene is also the material with the lowest resistivity because electric resistivity of graphene is lower than that of copper or silver.

In the prior arts, graphene is primarily manufactured by the methods of peeling graphite, directly growth and carbon nano-tube transformation. The method of peeling graphite can obtain the monolayer graphite powder, and is thus suitably applied to the mass production by use of redox reaction. First, graphite is oxidized to form graphite oxide, and then monolayer graphite is obtained by separating and reducing treatments.

US Patent Publication No. 20100303706 disclosed a process for the preparation of graphene, which includes reducing purified exfoliated graphite oxide in the presence of a base. Specifically, graphite oxide is dispersed in the base solution consisting of strong reductants, such as hydrazine and Sodium borohydride (NaBH4), and then stirred up to form reduced monolayer graphite. However, most reductants are poisonous such that the operation is highly risky.

Another US Patent Publication No. 20100221508 disclosed a method of reducing a film of graphite oxide, which includes a step of delivering optical energy between 0.1 and 2 J/cm² in a single pulse to the film of graphite oxide at a distance no more than 1.0 cm away from the film of graphite oxide for one second to reduce the film of graphite oxide to a film of graphene. This method is easy to implement, but the physical properties of the film of graphite oxide is hard to control. For example, if the reduction is insufficient, its properties are greatly affected.

U.S. Pat. No. 7,824,651 disclosed a method of exfoliating a layered material (e.g., graphite and graphite oxide) to produce nano-scaled platelets having a thickness smaller than 100 nm, typically smaller than 10 nm. More specifically, particles of a graphite material are dispersed in a liquid medium to form a suspension, and then the suspension is exposed to ultrasonication or grinding to produce separated nano-scaled platelets less than 10 nm. Although the operation is simple, the desired size of the nano-scaled platelets is difficult to meet by use of only mechanical force, and the processing time is very long, resulting in considerable power consumption.

In US Patent Publication No. 20100055025, graphite oxide is first provided to a heat source such that graphite oxide is peeled off into fine powder, and the fine powder is placed to another heat source in a protective atmosphere for a period of time so as to obtain final monolayer graphite. This invention is simple and fast, but the powder size and the oxygen content for mass production from batch to batch are hard to control within certain limited variation.

Therefore, it is desired to provide a method for manufacturing nano-graphene sheets using a mechanical peeling off process with high shear force to peel off or smash the nano-graphene sheets to improve the particle size and specific surface area, thereby overcoming the above problems in the prior arts.

### SUMMARY OF THE INVENTION

The primary objective of the present invention is to provide a method for manufacturing graphene sheets, which includes the steps of: intercalating and oxidizing, thermal flaking, mechanical flaking, drying, and reducing/heat treating. In the step of intercalating and oxidizing, a graphite material is intercalated and oxidized by mixing the graphite material with at least one intercalation agent and at least one oxidant. As a result, a large amount of carbon-oxygen functional groups are generated between the graphite layers of the graphite material and the graphite material is thus transformed into graphite oxide.

The step of thermal flaking is implemented by contacting the graphite oxide with a heat source more than 300° C. to thermally flake the graphite oxide to nano-graphite sheets. The oxygen content of the nano-graphite sheet is lower than that of the graphite oxide. This step is further performed in vacuum or protective or reductant atmosphere. For the step of mechanical flaking, the nano-graphite sheets are suspended in a liquid medium and a mechanical shear force larger than 5,000 psi is applied to mechanically flake the nano-graphite sheets to reduce the lateral size and thickness, resulting in a nano-graphene suspension solution.

In drying, the nano-graphene sheets are separated from the nano-graphene suspension solution by means of nebulization, and then dried in a hot gas stream under high pressure. Finally, the step of reducing/heat treating is performed by placing the nano-graphene sheets in the reductant atmosphere to further decrease the oxygen content to less than 3 wt % and reduce the crystal defects.

One aspect of the present invention is that the step of mechanically flaking employs high shear force to further reduce the particle size and thickness of the nano-graphene sheets after the step of thermally flaking so as to greatly improve the uniformity of the particle size and the specific surface area.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart showing the steps in the method for manufacturing nano-graphene sheets according to the present invention;

FIG. 2 is an X-ray Diffraction (XRD) diagram showing the nano-graphene sheets obtained by the experimental example 5 according to the present invention;

FIG. 3 is a Scanning Electron Microscope (SEM) view showing the nano-graphene sheets obtained by the experimental example 5 according to the present invention;

FIG. 4 is a Transmission Electron Microscopic (TEM) view showing the nano-graphene sheets obtained by the experimental example 5 according to the present invention; and

FIG. 5 is a Raman diagram for showing the nano-graphene sheets obtained by the experimental example 5 according to the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

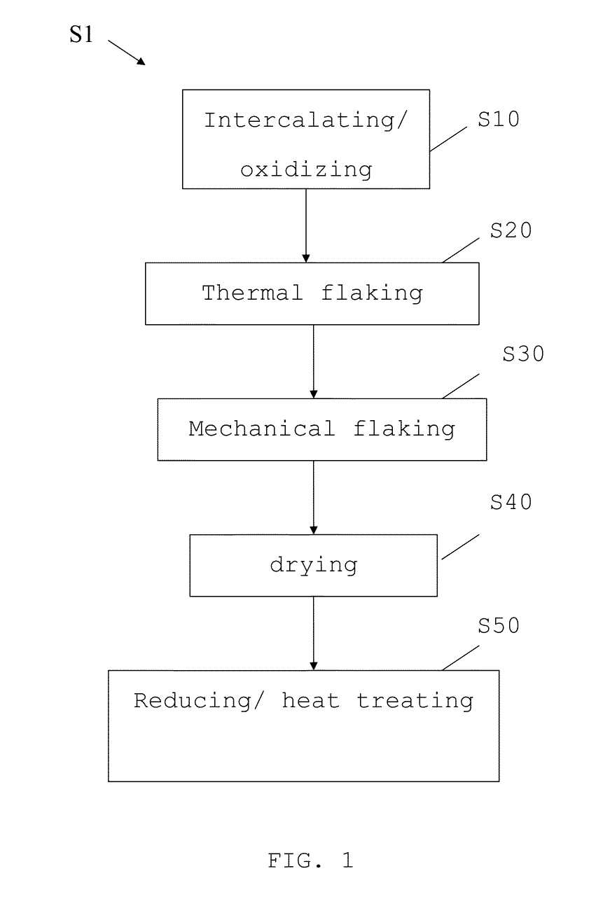

FIG. 1 is a flowchart showing the steps in the method for manufacturing nano-graphene sheets according to the present invention. As shown in FIG. 1, the method S1 of the present invention generally includes the steps of: intercalating and oxidizing S10, thermally flaking S20, mechanically flaking S30, drying S40, and reducing/heat treating S50.

Specifically, the step S10 is to mix the graphite material with at least one intercalation agent and at least one oxidant to cause the graphite material intercalated and oxidized such that a large amount of carbon-oxygen functional groups (like C—O, C═O, and so on) are generated between the graphite layers of the graphite material, thereby transforming the graphite material into graphite oxide. In particular, the density of graphite oxide is less than that of the graphite material.

Preferably, the graphite material is selected from a group consisting of at least one of natural graphite, expanded graphite, artificial graphite, graphite fiber, carbon nano-tube and mesophase carbon micro-bead, the intercalation agent is selected from a group consisting of at least one of sulfuric acid, nitric acid, phosphoric acid, hydrochloric acid, phosphoric anhydride and carboxylic acid, and the oxidant is selected from a group consisting of at least one of potassium permanganate, perchloric acid and hydrogen peroxide. The process of oxidation herein is implemented by the general Hummers method, but not limited to it. The intercalation agent is within a range of 500-3000 wt % of the graphite material, and the oxidant is within a range of 100-1000 wt % of the graphite material.

Next, in the step S20, the graphite oxide is taken out to contact the heat source at a temperature up to more than 300° C. to thermally flake the graphite oxide to a plurality of nano-graphite sheets. The nano-graphite sheet has the oxygen content less than the oxygen content of the original graphite oxide. The step S20 is based on the specific theory that the functional groups containing oxygen are fast removed by evaporation and gasification when the graphite oxide contacts the heat source, then a large amount of gas like carbon monoxide and carbon dioxide gives off to swell the resultant structure of the graphite oxide, and finally the graphite oxide is fast expanded and flaked to form the nano-graphite sheets. Because the oxygen contained in the graphite oxide is removed by gasification, the content of the graphite oxide remaining in the nano-graphite sheets is greatly lowered. Furthermore, the step S20 is performed in the vacuum or the protective or reductant atmosphere in order to prevent oxygen gas from re-oxidation with the nano-graphite sheets. The protective atmosphere consists of at least one of helium (He), argon (Ar) and nitrogen (N₂), and the reductant atmosphere comprises at least one of hydrogen (H₂), ammonia (NH₃) and carbon monoxide (CO).

Additionally, the graphite oxide is thermally expanded and flaked upon instantly contacting the heat source higher than 300° C. The reaction becomes stronger and the nano-graphite sheets are smaller as the temperature gets higher. The optimal temperature is within a range of 500-1300° C., and the period of time of contacting with the heat source is less than 3 minutes.

In the step S30, the nano-graphite sheets are suspended in a liquid medium, which consists of at least one of water and organic solvent. A dispersant is further contained in the liquid medium. A mechanical shear force with shear strength larger than 5,000 psi is then imposed to reduce the lateral size and thickness of the nano-graphite sheets so as to mechanically flake the nano-graphite sheets to form the nano-graphene sheets, which are mixed with the liquid medium to form the nano-graphene suspension solution. The above shear force is generated by at least one of ultrasonication, high speed mixing, normal pressure homogenizer, planet bead milling, and high pressure homogenizer.

For the step S30, it is believed that the distance between two adjacent nano-graphite sheets produced by oxidation and thermal flaking is increased, and the Van Der Waals force between the nano-graphite sheets is relatively decreased such that the nano-graphite sheets are effectively separated by the shear force externally imposed to form the nano-graphene sheets. On the contrary, without the oxidation and thermal flaking of graphite as the pre-treatments, imposing only mechanical shear force on graphite can not overcome the Van Der Waals force between the nano-graphite sheets. As a result, the yield for the nano-graphene sheets is considerable low, or the desired thickness is not fulfilled.

For the step S40, the nano-graphene suspension solution is dried and the nano-graphene sheets are separated. To prevent the nano-graphene sheets from re-congregation and agglomeration during the process of drying, the preferred means to implement is that the nano-graphene suspension solution is first nebulized, and then dries and separated by the hot gas stream at high pressure so as to keep the resultant nano-graphene sheets separate without agglomeration after drying.

Finally, the step S50 is performed by placing the nano-graphene sheets into the reductant atmosphere and heating up to a heat treatment temperature to reduce the oxygen content of the nano-graphene sheets to less than 3 wt % so as to decrease crystal defects. The reductant atmosphere consists of at least one of hydrogen (H₂), ammonia (NH₃) and carbon monoxide (CO), and the heat treatment temperature is preferably 500-1200° C. Additionally, it is preferred that the heat treatment takes 30-120 minutes.

Therefore, the nano-graphene sheet manufactured by the method of the present invention has some excellent physical properties like the oxygen content less than 3wt %, the carbon content larger than 95 wt %, the average particle size less than 30m,and the specific surface area larger than 15 m²/g.

Some examples are illustrated hereinafter to clearly explain the aspects of the present invention, and it is obvious that these examples are not intended to limit the scope of the present invention.

For the illustrative examples, the step S 10 of intercalating and oxidizing is implemented by placing 10 g natural graphite powder into 230 ml sulfuric acid (H₂SO₄), slowly adding 30 g potassium permanganate (KMnO₄) in water bath and stirring up the solution. The temperature of the solution is maintained below 20° C. After that, the solution is stirred up for 40 minutes at 40° C., then 460 ml deionized water is slowly added, and the solution in water bath is kept at 35° C. for at least 20 minutes with continuously stirring up. After the reaction completes, 1.4 L deionized water and 100 ml hydrogen peroxide (H₂O₂) solution are added, and the resultant solution still for 24 hours. Finally, the solution is washed by 5% hydrogen chloride, and then filtered and dried in vacuum to obtain the graphite oxide powder.

Next, the graphite oxide powder contacts the heat source at 1,000° C. in vacuum for 1 minute to perform the step of thermal flaking such that the nano-graphite sheets are obtained. After that, enter the step S30.

The nano-graphite sheets are suspended in the alcohol solution and imposed by the shear force to form the nano-graphene suspension solution. Specifically, examples 1, 2 and 3 respectively correspond based on different strength of shear forces. The step S40 is then performed, and the respective nano-graphene suspension solutions of examples 1, 2 and 3 are passed through a nebulization device to form nebulized drops. The nebulized drops are fast dried by contacting the hot air at 200° C., and are further forced to flow into the gas-solid separation device to collect the dried nano-graphene sheets. At this time, Table 1 shows the respective sizes of the nano-graphene sheets in examples 1, 2 and 3.

TABLE 1

| | Strength of | Average | Specific | |
|---|---|---|---|---|
| | shear force | particle size | surface | Thickness |
| | (psi) | D₅₀(μm) | area(m²/g) | (nm) |
| example 1 | 8000 | 18.7 | 16.2 | 77 |
| example 2 | 20,000 | 14.2 | 21.5 | 39 |
| example 3 | 30,000 | 9.8 | 24.7 | 12 |

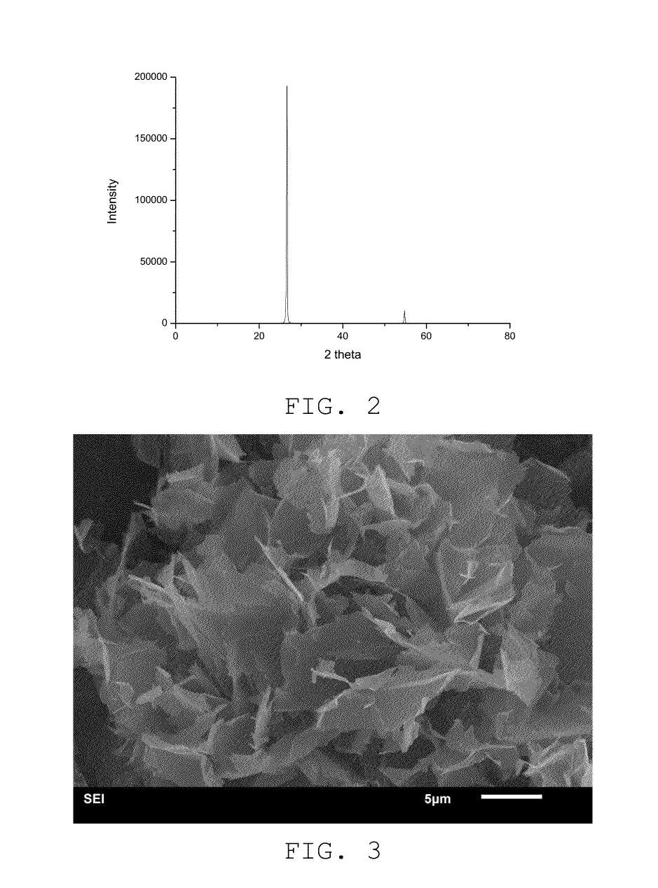

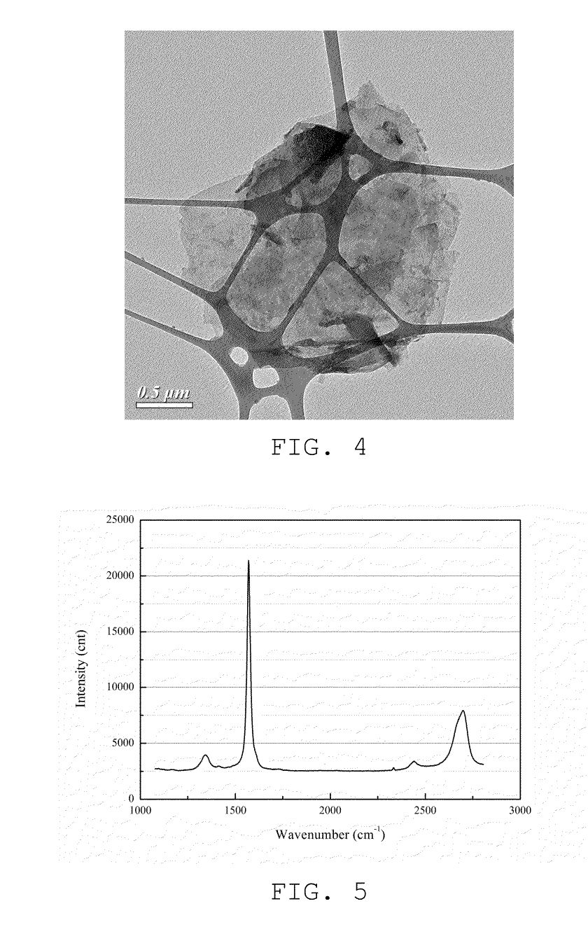

For example 3, the nano-graphene sheets are placed in 5% hydrogen gas and 95% argon gas at 500° C. and 1,100° C. for 1 hour, respectively, to perform the step S50, and the processed nano-graphene sheets are specified by examples 4 and 5. Table 2 shows the variation of the oxygen content for examples 4 and 5. Additionally, the X-ray diffraction, SEM, TEM and Raman diagram for example 5 are shown in FIGS. 2-5, respectively.

TABLE 2

| | Heat treatment | Oxygen content after heat |
|---|---|---|
| | temperature | treatment (wt %) |
| example 4 | 500° C. | 9.6 |
| example 5 | 1,100° C. | 2.8 |

The Example 6 is illustrated for large scale production. First, 160 g graphite is placed into 4 L sulfuric acid (H₂SO₄), and slowly adding 480 g potassium permanganate (KMnO₄) in ice bath and stirring up the solution. The above process is maintained below 20° C. After that, it takes 40 minutes to further stir up at 40° C., then 47.37 L deionized water is slowly added, and the solution is kept in water bath at 35° C. for at least 20 minutes with continuously stirring up. After the reaction completes, 22.4 L deionized water and 1.6 L hydrogen peroxide (H₂O₂) solution are added, and the resultant solution stands still for 24 hours. The solution is washed by 5% hydrogen chloride, and then filtered and dried in vacuum to obtain the graphite oxide powder.

The step S20 is then performed by placing the graphite oxide powder in contact with the heat source at 1,000° C. in vacuum for 1 minute, and the nano-graphite sheets are obtained. Enter the next step S30.

The nano-graphite sheets are suspended in the alcohol solution and imposed by the specific shear force 30,000 psi to form the nano-graphene suspension solution. The step S40 is then performed by nebulizing the nano-graphene suspension solution through the nebulization device to form the nebulized drops. The nebulized drops are fast dried by contacting the hot air at 200° C., and further flow into the gas-solid separation device to collect the dried nano-graphene sheets. Finally, the nano-graphene sheets are placed in 5% hydrogen gas and 95% argon gas at 1,100° C. for 1 hour to perform the step S50. The average particle size of the final nano-graphene sheets is 9 μm and its specific surface area is 26 m²/g.

From the above-mentioned, one aspect of the present invention is that the step of mechanically flaking employs high shear force to further reduce the particle size and thickness of the nano-graphene sheets after the step of thermally flaking so as to greatly improve the uniformity of the particle size and the specific surface area.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for manufacturing nano-graphene sheets, comprising steps of:
intercalating and oxidizing a graphite material to form a graphite oxide by mixing the graphite material with at least one intercalation agent and at least one oxidant;
contacting the graphite oxide with a heat source to thermally flake the graphite oxide to a plurality of nano-graphite sheets;
suspending the nano-graphite sheets in a liquid medium and applying a mechanical shear force to mechanically flake the nano-graphite sheets such that a lateral size and a thickness of the nano-graphite sheets are reduced to form a nano-graphene suspension solution;
separating the nano-graphene sheets from the nano-graphene suspension solution and drying the nano-graphene sheets;
placing the nano-graphene sheets into a reductant atmosphere and heating up to a heat treatment temperature to reduce an oxygen content of the nano-graphene sheets so as to decrease crystal defects.

2. The method as claimed in claim 1, wherein the graphite material is selected from a group consisting of at least one of natural graphite, expanded graphite, artificial graphite, graphite fiber, carbon nano-tube and mesophase carbon micro-bead.

3. The method as claimed in claim 1, wherein the intercalation agent is selected from a group consisting of at least one of sulfuric acid, nitric acid, phosphoric acid, hydrochloric acid, phosphoric anhydride and carboxylic acid.

4. The method as claimed in claim 1, wherein the oxidant consists of at least one of potassium permanganate and perchloric acid.

5. The method as claimed in claim 1, wherein the intercalation agent is in a range of 500 to 3000 wt % of the graphite material, the oxidant is in a range of 100 to 1000 wt % of the graphite material, and the graphite oxide has a density less than a density of the graphite material.

6. The method as claimed in claim 1, wherein the heat source is provided with temperature within a range of 500 to 1300° C., and a period of time of contacting with the heat source is less than 3 minutes.

7. The method as claimed in claim 1, wherein the liquid medium consists of at least one of water and organic solvent.

8. The method as claimed in claim 7, wherein the liquid medium further consists of a dispersant.

9. The method as claimed in claim 1, wherein the reductant atmosphere consists of at least one of hydrogen (H₂), ammonia (NH₃) and carbon monoxide (CO), a temperature of the heat treatment is 500-1200° C., and the heat treatment takes 30-120 minutes.

10. The method as claimed in claim 1, wherein the liquid medium is deionized water and/or an organic solvent, the shear force is generated by at least one of ultrasonication, high speed mixing, normal pressure homogenizer, planet bead milling, and high pressure homogenizer, and the mechanical shear force is larger than 5,000 psi.

11. The method as claimed in claim 1, wherein the nano-graphene sheet has an oxygen content less than 3 wt %, a carbon content larger than 95 wt %, an average particle size less than 30 gm, and a specific surface area larger than 15 m²/g.
